(19) United States
(12) Patent Application Publication
(10) Pub. No.: US 2013/0307755 A1
(43) Pub. Date: Nov. 21, 2013

(54) APPARATUS, SYSTEM AND METHOD FOR IMAGE ADJUSTMENT

(71) Applicant: Sony Corporation, Tokyo (JP)

(72) Inventor: Hideo Tomita, Kanagawa (JP)

(73) Assignee: Sony Corporation, Tokyo (JP)

(21) Appl. No.: 13/893,778

(22) Filed: May 14, 2013

(30) Foreign Application Priority Data
May 21, 2012 (JP) 2012-115392

(51) Int. Cl. G06F 3/14

(52) U.S. Cl. CPC G06F 3/1423
USPC 345/1.1

(57) ABSTRACT

An apparatus for image adjustment includes an acquisition unit, a detection unit, and a correction unit. The acquisition unit obtains a reference image obtainable by a reference pattern image being captured by an imaging apparatus. The reference pattern image is projected by any single projector out of a plurality of projectors, as a synthesized image of pattern images which can be projected by the projectors and have different colors with each other. The reference pattern image has a combination color of the different colors. The detection unit detects, on the basis of data of the reference image, a chromatic aberration-derived positional deviation which is a positional deviation in the pattern images corresponding to a chromatic aberration that occurs due to the imaging apparatus. The correction unit corrects, the positional deviation of the pattern images each being projected by the corresponding projector, using data of the chromatic aberration-derived positional deviation.

### BACKGROUND

The present disclosure relates to a technique of such as an apparatus for image adjustment, which adjusts an image projected from a plurality of projectors.

From the past, there is a technique in which a plurality of images projected from a plurality of projectors are synthesized on a screen, for the purpose of achieving high-definition or high brightness of an image. Further, there have also been proposed methods of alignment of each of the projected images on the screen, that is, methods for adjustment of positional deviations.

For example, in a method of adjusting positions to display images by projectors, described in Japanese

Patent Application Laid-open No. 2011-182291, each of the four corners of a rectangular screen is captured by a corresponding camera, by the use of four cameras, and a positional deviation between images projected from two projectors is detected. Further, in this method of adjusting, a correction value corresponding to an amount of error against reference pixel position in the projected images is calculated. On the basis of this correction value, the position to display the projected images is adjusted (for example, see paragraphs [0070] and [0078] of Japanese Patent Application Laid-open No. 2011-182291, and the like).

### SUMMARY

Images obtained by imaging apparatus such as cameras may have an occurrence of chromatic aberrations due to positional settings of the imaging apparatus and various parameters such as angle of view and zoom scale. In systems which perform adjustment of positions of images projected from the respective projectors based on the images obtained by the imaging apparatus, the adjustment of positions of images becomes difficult to be made with high precision when the chromatic aberration has occurred.

In view of the above-mentioned circumstances, it is desirable to provide an apparatus, a system and a method for image adjustment that can correct positional deviations of the projected images with high precision even in cases where chromatic aberrations may occur.

According to an embodiment of the present disclosure, there is provided an apparatus for image adjustment, including an acquisition unit, a detection unit, and a correction unit.

The acquisition unit is configured to obtain a reference image obtainable by a reference pattern image being captured by an imaging apparatus. The reference pattern image is an image being projected by any single projector out of a plurality of projectors, as a synthesized image of pattern images, each of which pattern images can be projected by a corresponding projector in the plurality of projectors and has a color different to each other, and is an image having a combination color of the different colors of the pattern images.

The detection unit is configured to detect, on the basis of data of the reference image, a chromatic aberration-derived positional deviation which is defined to be a positional deviation in the pattern images corresponding to a chromatic aberration that occurs due to the imaging apparatus.

The correction unit is configured to correct, using data of the chromatic aberration-derived positional deviation, the positional deviation of the pattern images each being projected by the corresponding projector.

In the present disclosure, by allowing one projector to project the reference pattern image having the combination color of the pattern images, which pattern images can be projected by the plurality of projectors, it allows this reference pattern image to be regarded as an image in which the positions of the respective pattern images projected from the projectors are coincident. By capturing this reference pattern image by the imaging apparatus, it allows the positional deviation of the pattern images each included in the captured reference image to be regarded as the positional deviation due to the chromatic aberration. By using this chromatic aberration-derived positional deviation, the correction unit is able to correct, with high precision, the positional deviations of the pattern images each actually being projected.

The detection unit may be configured to detect the chromatic aberration-derived positional deviation by extracting pixel values, from the data of the reference image, for at least two pixels located across a peak pixel from each other in a direction of the chromatic aberration-derived positional deviation, in which the peak pixel has a peak pixel value obtainable from the data of the reference image, and generating comparison data of the extracted pixel values.

By allowing the detection unit to generate the comparison data comparing the pixel values for at least two pixels located across a peak pixel from each other, the following becomes possible. That is, even if the peak positions of the peak luminance values (peak pixel values) within the pattern images that may appear due to the chromatic aberration in the data of the reference image are too close to each other, the chromatic aberration-derived positional deviation thereof can be detected by using the comparison data. As a result, image adjustment with high precision can be performed.

The detection unit may be configured to extract, as the pixel values, pixel values for at least two pixels that are adjacent to the peak pixel.

Alternatively, the detection unit may be configured to extract pixel values for a plurality of pixels contiguous to the peak pixel in at least both sides of the peak pixel in the direction of the chromatic aberration-derived positional deviation. By extracting the pixel values for a plurality of pixels contiguous to the peak pixel in the both sides of the peak pixel, the detection of the positional deviation can be performed with high precision.

The detection unit may be configured to obtain the comparison data by calculating, using a predetermined algorithm, on the basis of the extracted pixel values.

The acquisition unit may be configured to obtain, as the reference image, an image obtainable by the reference pattern image being captured by the imaging apparatus, which reference pattern image has a third color. The third color is a color synthesized from a first color of a first pattern image and a second color of a second pattern image, out of the pattern images, each of which pattern images can be projected by the corresponding projector.

In that case, the detection unit may be configured to extract the pixel value for the first color of the first pattern image and the pixel value for the second color of the second pattern image for each of the contiguous pixels. Further, the detection unit may be configured to obtain the comparison data on the basis of a sum of arctangent values, of the ratio of the pixel value for the first color to the pixel value for the second color, of the plurality of pixels. Alternatively, the detection unit may be configured to obtain the comparison data on the basis of a sum of differences, or ratios, between the pixel value for the first color and the pixel value for the second color, of the plurality of pixels. As a result, the detection unit can detect the positional deviation, by simple calculations, with high precision.

The acquisition unit may be configured to further obtain a captured image obtainable by capturing each of the pattern images being projected by the corresponding projector, by the imaging apparatus. Further, the detection unit may be configured to detect the positional deviation by extracting pixel values, from the data of the captured image, for at least two pixels located across a peak pixel from each other in a direction of the positional deviation, in which the peak pixel has a peak pixel value obtainable from the data of the captured image, and by generating comparison data of the extracted pixel values. As a result, even if the peak positions of the peak luminance values (peak pixel values) within each of the pattern images that may appear in the data of the captured image are too close to each other, an actual positional deviation thereof can be detected by using the comparison data.

The correction unit may be configured to calculate, as an actual positional deviation, a value after subtracting a value that corresponds to the aberration-derived positional deviation from a value that corresponds to the positional deviation. As a result, image adjustment with higher precision can be performed.

The detection unit may be configured to perform a detection process on at least a predetermined partial area out of the reference image. This partial area may either be one partial area or a plurality of partial areas.

Now, regardless of whether or not the chromatic aberration due to the imaging device would occur, with a trend of higher image quality in recent years, it is necessary to perform image adjustment with high precision.

In view of this, according to another embodiment of the present disclosure, there is provided another apparatus for image adjustment including an acquisition unit, a detection unit and a correction unit.

An acquisition unit is configured to obtain a captured image obtainable by capturing pattern images, each of which pattern images is projected by a corresponding projector in a plurality of projectors and has a color different to each other, by an imaging apparatus.

A detection unit is configured to detect a positional deviation by extracting pixel values for at least two pixels located across a peak pixel from each other in a direction of the positional deviation in the pattern images, in which the peak pixel has a peak pixel value obtainable from the data of the captured image, and generating comparison data of the extracted pixel values.

A correction unit is configured to correct the detected positional deviation.

By allowing the detection unit to generate the comparison data comparing the pixel values for at least two pixels located across a peak pixel from each other, the following becomes possible. That is, even if the peak positions of the peak luminance values (peak pixel values) within the pattern images that may appear in the data of the captured image are too close to each other, the positional deviation thereof can be detected by using the comparison data. As a result, image adjustment with high precision can be performed.

According to another embodiment of the present disclosure, there is provided a system for image adjustment, which system includes a plurality of projectors, an imaging apparatus and an apparatus for image adjustment.

The imaging apparatus is configured to capture a reference pattern image. The reference pattern image is projected by any single projector out of the plurality of projectors, as a synthesized image of pattern images, each of which pattern images can be projected by a corresponding projector in the plurality of projectors and has a color different to each other, and the reference pattern image has a combination color of the different colors of the pattern images.

The apparatus for image adjustment includes an acquisition unit, a detection unit and a correction unit. The acquisition unit is configured to obtain a reference image which is obtainable by being captured by the imaging apparatus. The detection unit is configured to detect, on the basis of data of the reference image, a chromatic aberration-derived positional deviation which is defined to be a positional deviation in the pattern images corresponding to a chromatic aberration that occurs due to the imaging apparatus. The correction unit is configured to correct, using data of the chromatic aberration-derived positional deviation, the positional deviation of the pattern images each being projected by the corresponding projector.

According to another embodiment of the present disclosure, there is provided another system for image adjustment, which system includes a plurality of projectors, an imaging apparatus and an apparatus for image adjustment.

The imaging apparatus is configured to capture pattern images, each of which pattern images is projected by a corresponding projector in the plurality of projectors and has a color different to each other.

The apparatus for image adjustment includes an acquisition unit, a detection unit and a correction unit. The acquisition unit is configured to obtain a captured image obtainable by capturing by the imaging apparatus. The detection unit is configured to detect a positional deviation by extracting pixel values for at least two pixels located across a peak pixel from each other in a direction of the positional deviation in the pattern images, in which the peak pixel has a peak pixel value obtainable from the data of the captured image, and generating comparison data of the extracted pixel values. The correction unit is configured to correct the detected positional deviation.

According to another embodiment of the present disclosure, there is provided a method for image adjustment, which method includes projecting a reference pattern image as a synthesized image of pattern images, by any single projector out of a plurality of projectors, each of which pattern images can be projected by a corresponding projector in the plurality of projectors and has a color different to each other, the reference pattern image having a combination color of the different colors of the pattern images.

The reference pattern image is captured by an imaging apparatus.

A reference image obtainable by the capturing by the imaging apparatus is obtained.

On the basis of data of the reference image, a chromatic aberration-derived positional deviation which is defined to be a positional deviation in the pattern images corresponding to a chromatic aberration that occurs due to the imaging apparatus is detected.

Using data of the chromatic aberration-derived positional deviation, the positional deviation of the pattern images each being projected by the corresponding projector is corrected.

According to another embodiment of the present disclosure, there is provided another method for image adjustment, which method includes projecting pattern images by a plurality of projectors, each of which pattern images has a color different to each other and is to be projected by a corresponding projector in the plurality of projectors.

The projected pattern images are captured by an imaging apparatus.

A captured image obtainable by the capturing by the imaging apparatus is obtained.

Pixel values for at least two pixels located across a peak pixel from each other in a direction of the positional deviation in the pattern images, in which the peak pixel has a peak pixel value obtainable from the data of the captured image, are extracted.

The positional deviation is detected, by generating comparison data of the extracted pixel values.

The detected positional deviation is corrected.

As described above, according to the embodiments of the present disclosure, even in cases where chromatic aberrations may occur, positional deviations of the projected images can be corrected with high precision.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 a block diagram showing the configuration of a system for image adjustment according to an embodiment of the present disclosure;

FIG. 2 shows test pattern images (pattern images) that an image storage apparatus outputs via projectors, which pattern images have different colors with each other;

FIG. 3 shows some areas out of the test pattern images to detect a positional deviation;

FIG. 4 shows examples of distortions and positional deviations in the test pattern images, and examples of their various corresponding correction commands;

FIG. 5 is a flowchart showing the operation of the system for image adjustment;

FIG. 6 shows a form in which a reference pattern image is projected by any single projector;

FIG. 7 shows the areas having the peak luminance of green light and of red light, in a predetermined area out of the images projected from the projectors, and shows the distributions of their peak luminance;

FIGS. 8A to 8C are diagrams explaining a fact that green light in an image projected from a projector contains a component of red light, and that these are difficult to be separated from each other;

FIGS. 9A and 9B show pixel values for a red peak pixel and for contiguous pixels adjacent thereto in the horizontal direction from the peak pixel at the center, in which the peak pixel and the contiguous pixels are within the captured image obtained by an apparatus for image adjustment;

FIG. 10 is a diagram explaining a generation of comparison data.

### DETAILED DESCRIPTION OF EMBODIMENTS

Hereinafter, embodiments of the present disclosure will be described with reference to the drawings.

[Configuration of system for image adjustment]

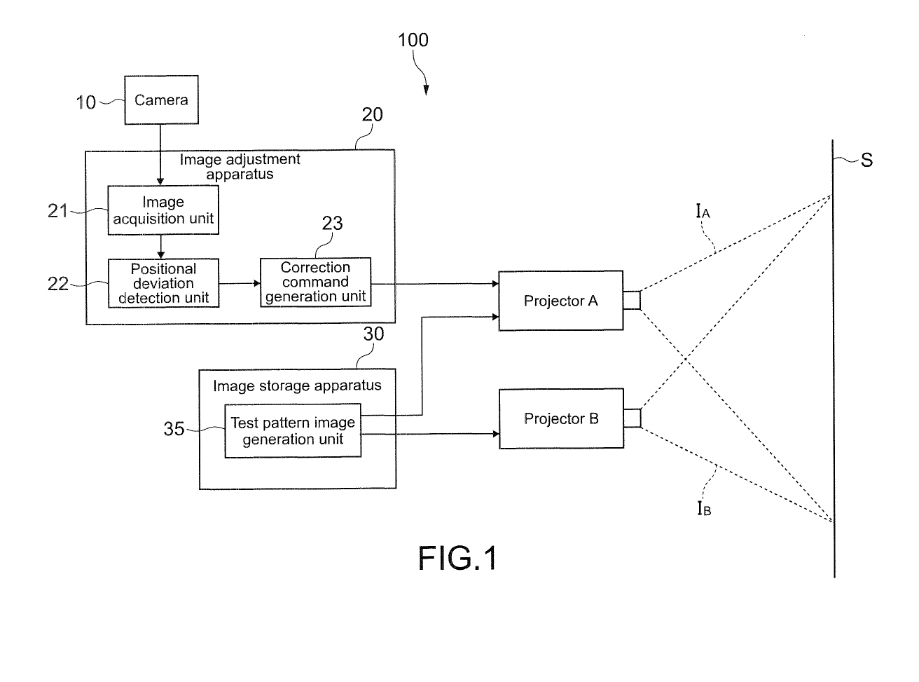

FIG. 1 is a block diagram showing the configuration of an image adjustment system 100 according to an embodiment of the present disclosure.

The image adjustment system 100 includes two projectors A and B as a plurality of projectors, a camera 10 which is an imaging apparatus, an image adjustment apparatus 20 and an image storage apparatus 30.

The image storage apparatus 30 has a test pattern image generation unit 35 which is configured to generate (or store in advance) a test pattern image for image adjustment, which test pattern image will be described later. The image storage apparatus 30 is configured to output the generated test pattern image to each of the projectors A and B.

In addition, after finishing the image adjustment by this image adjustment system 100, a viewer who is a user that uses the projectors A and B is able to view images (which may include videos and the like) which are output from the image storage apparatus 30 and are projected on a screen S from the projectors A and B. Examples of apparatus that can be applied as the image storage apparatus 30 include a hard disk recorder and other apparatus configured to store images and to output images. The images which are output from the image storage apparatus may either be 2D (Dimension) images or 3D images. In cases where the images are 3D images, each of the images with a parallax is projected from the corresponding one of the two projectors. The projectors A and B are disposed in such a manner that each of the positions of the images being projected from the projectors A and B, ideally, would be coincident with each other on the screen S.

The camera 10 is connected to the image adjustment apparatus 20 through an interface such as USB (Universal Serial Bus), typically. The camera 10 is configured to capture a whole image being projected on the screen S (the above-mentioned test pattern image). A resolution of the camera 10 is desirable to be almost equal to or higher than that of the projectors A and B.

The image adjustment apparatus 20 and the projector A are connected to each other through an interface such as S232C, typically.

The image adjustment apparatus 20 has functional blocks of an image acquisition unit 21, a positional deviation detection unit 22 and a correction command generation unit 23. These functional blocks may either be realized by hardware alone or by cooperating of hardware and software.

The image acquisition unit 21 functions as an acquisition unit which is configured to obtain the image captured by the camera 10. The positional deviation detection unit 22 functions as a detection unit which is configured to analyze this captured image and to detect a relative positional deviation of each test pattern image projected from the corresponding one of the projectors A and B, on the screen S. The correction command generation unit 23 functions as a correction unit which is configured to generate a correction command for correcting the positional deviation and to send it to the projector A. The projector A receives this correction command, allows the image to be electrically distorted in accordance with the correction command and projects the image.

That is, the correction command generation unit 23 outputs a signal as a correction command to the projector A, which signal allows a test pattern image projected from the projector A to be deformed in such a manner that the test pattern image projected from the projector A coincides with a test pattern image projected from the projector B. In this embodiment, a test pattern image I_{B} projected from the projector B serves as a reference, and a test pattern image I_{A} projected from the projector A is controlled to approach this test pattern image I_{B}.

The image adjustment apparatus 20 is made up with a computer, for example, using hardware such as CPU (Central Processing Unit), RAM (Random Access Memory) and ROM (Read Only Memory), which are not shown in the drawings, as the above-mentioned hardware. PLD (Programmable Logic Device) such as FPGA (Field Programmable Gate Array); and other devices such as ASIC (Application Specific Integrated Circuit) may be provided instead of hardware such as CPU. As a typical example, a PC (Personal Computer) may be used as the image adjustment apparatus 20.

[Test pattern images]

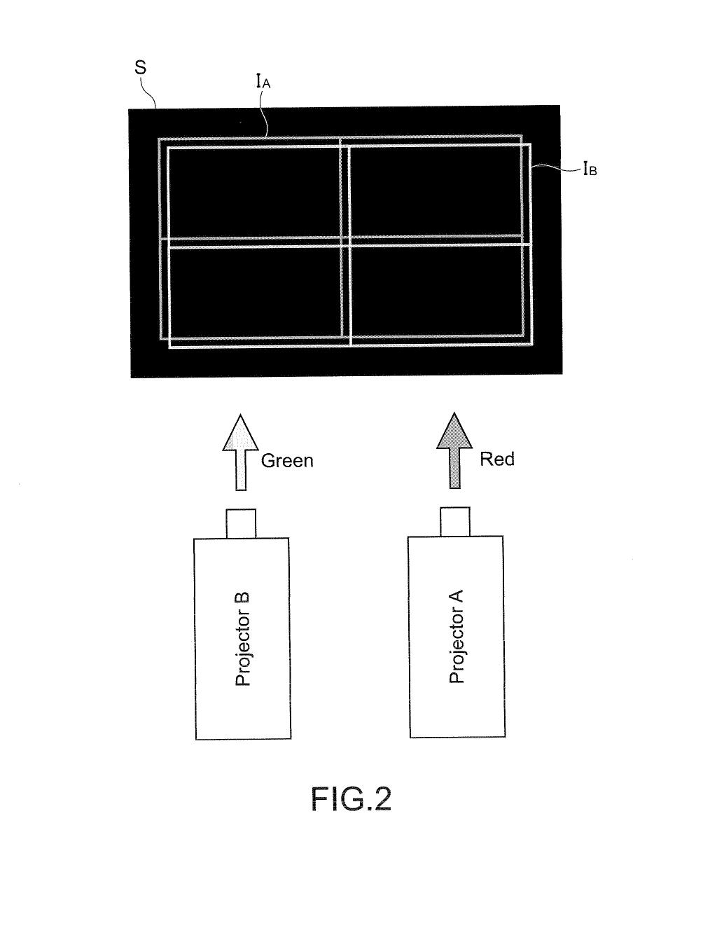

FIG. 2 shows test pattern images (pattern images) I_{A} and I_{B} that the image storage apparatus 30 outputs via the projectors A and B, each of which pattern images has a color different to each other. Each of the test pattern images I_{A} and I_{B} has a shape in which a cross is disposed within a rectangular frame, and ideally has the same size and shape with each other. Examples of colors to be used as colors of these test pattern images I_{A} and I_{B}, basically, are the colors selected from among three primary colors (red, green and blue). The color of the test pattern image I_{A} projected from the projector A is red (first color, for example), and the color of the test pattern image I_{B} projected from the projector B is green (second color, for example).

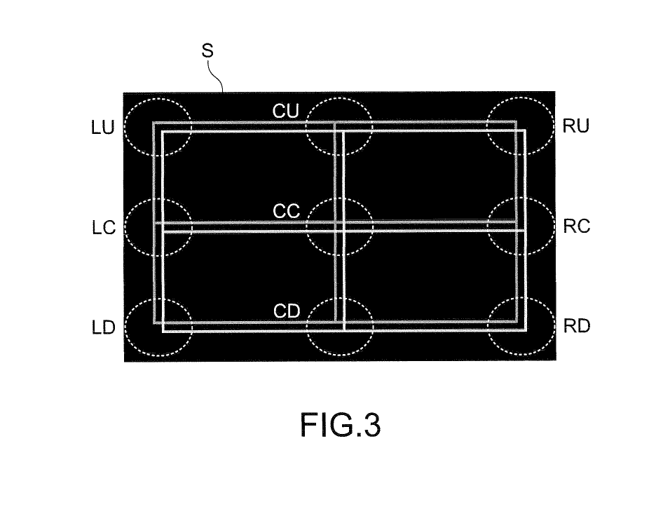

FIG. 3 shows some areas out of the test pattern images I_{A} and I_{B} to detect a positional deviation. The camera 10, as described above, captures the whole image of the test pattern images I_{A} and I_{B} on the screen S. The image adjustment apparatus 20 is configured to detect positional deviations of the test pattern images I_{A} and I_{B} by performing detection in each of nine areas in total, of the four corner areas out of the whole image, one area at the center and four ends of the cross-shaped area. In FIG. 3, the nine areas of detection are denoted by LU, LC, LD, CU, CC, CD, RU, RC and RD. Examples of “positional deviations” in rough adjustment will be defined as follows.

“LUx”: A positional deviation of a detection point (coordinate of the top left corner) in the test pattern image I_{A}, in the x direction with respect to the test pattern image I_{B}. If the detection point is located at the left side with respect to the test pattern image I_{B} in the x direction, LUx is positive. In opposite cases, LUx is negative.

“LUy”: A positional deviation of a detection point (coordinate of the top left corner) in the test pattern image I_{A}, in the y direction with respect to the test pattern image I_{B}. If the detection point is located at the upper side with respect to the test pattern image I_{B} in the y direction, LUy is positive. In opposite cases, LUy is negative.

That is, the “positional deviation” in this embodiment represents a direction of deviation (positive or negative), of a predetermined area (predetermined detection point) of one test pattern image I_{A}, with respect to the other test pattern image I_{B}.

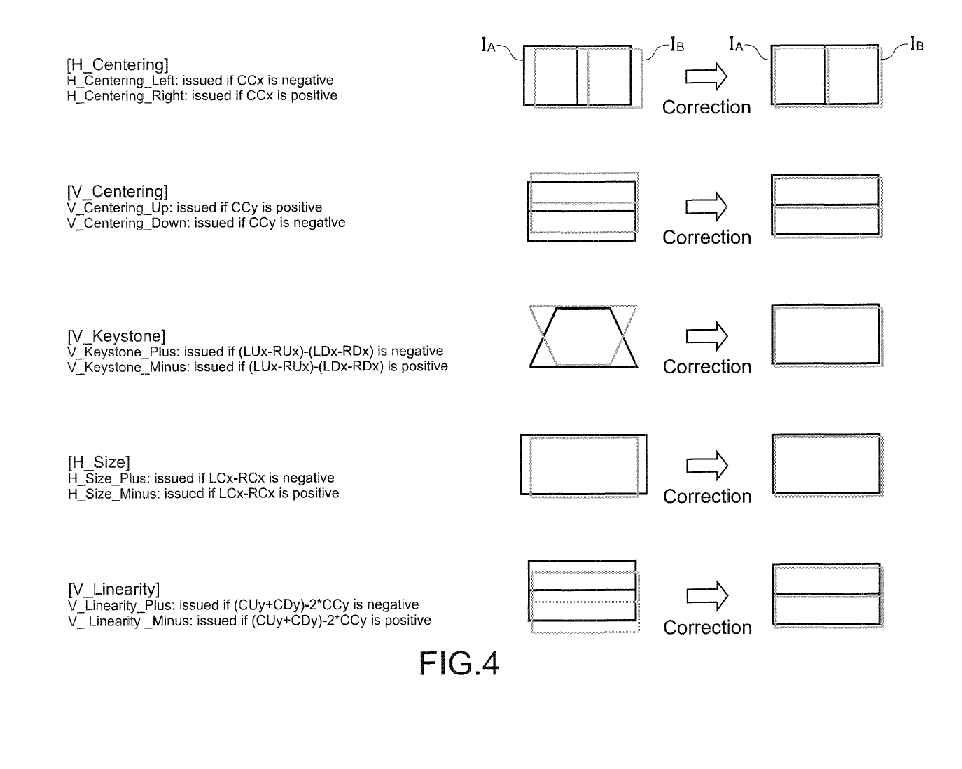

FIG. 4 shows examples of distortions and positional deviations in the test pattern images, and examples of their various corresponding correction commands. The correction commands to the positional deviations in the rough adjustment may be set as follows.

“H Centering”: A positional deviation in the horizontal direction of the longitudinal center line

“V Centering”: A positional deviation in the vertical direction of the longitudinal center line

“V Keystone”: A positional deviation in the horizontal direction of the four corners (four points) “H Size”: A positional deviation in the horizontal direction of the longitudinal lines at the both ends in the horizontal direction

“V Linearity”: A positional deviation in the vertical direction of the horizontal lines at the both ends in the vertical direction

For example, a correction command called “H_Centering_Left” may be issued in cases where the detection point in the detection area CC (the intersection CCx of the vertical center line and the horizontal center line) in the test pattern image I_{A} is negative. The case where it is negative is, for example, that the detection point CCx is shifted to the right with respect to the corresponding point in the detection area CC (the intersection of the vertical center line and the horizontal center line) in the test pattern image I_{B}, in which case the command may be issued. As another example, a correction command called “V_Keystone_Plus” may be issued in cases where (LUx-RUx)−(LDx-RDx) in the test pattern image I_{A} is negative.

By executing the above six patterns of correction processes, in the rough adjustment, the image adjustment apparatus aligns the positions of the test pattern images I_{A} and I_{B} to some extent. After the rough adjustment, fine adjustment is performed, as will be described later.

### [Operation of system for image adjustment]

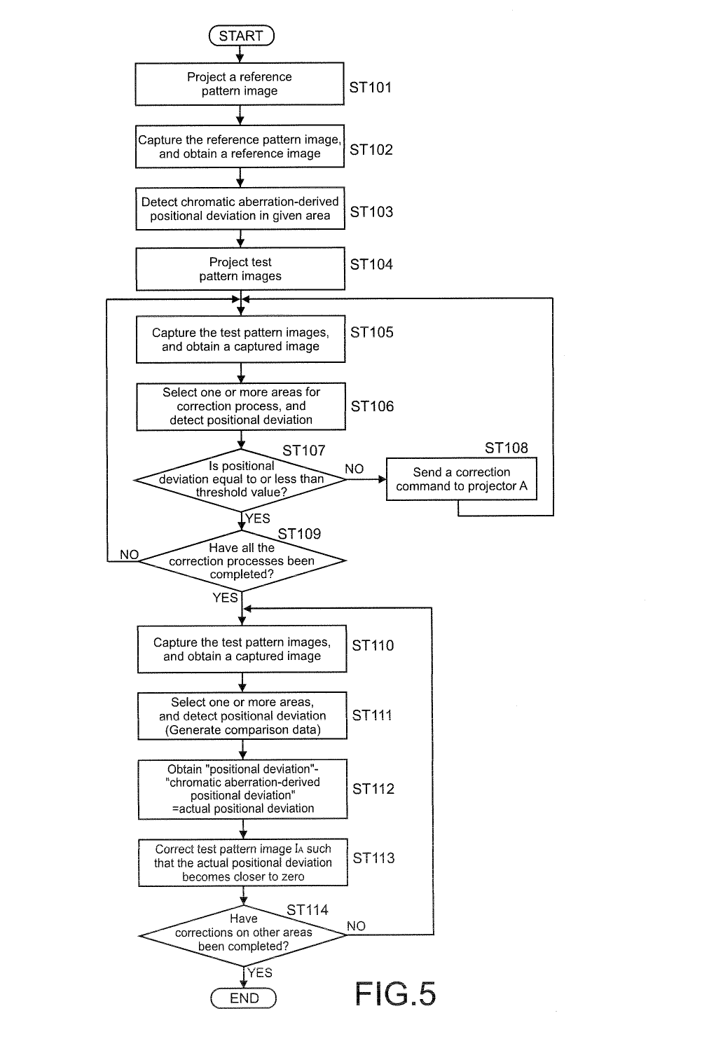

Hereinafter, an operation of the image adjustment system 100 will be described. FIG. 5 is a flowchart which shows this operation, mainly showing processes of the image adjustment apparatus 20.

Images captured by the camera 10 may have an occurrence of chromatic aberrations due to the location of the camera 10, individual differences in camera lens and various parameters such as zoom and angle of view. In order to enable high-precision image adjustment, such chromatic aberrations should be taken into account. In view of this, the image adjustment apparatus 20 allows a projector, which is any single projector out of the plurality of projectors and is the projector B in this case, to output a reference pattern image I_{ref} (step 101).

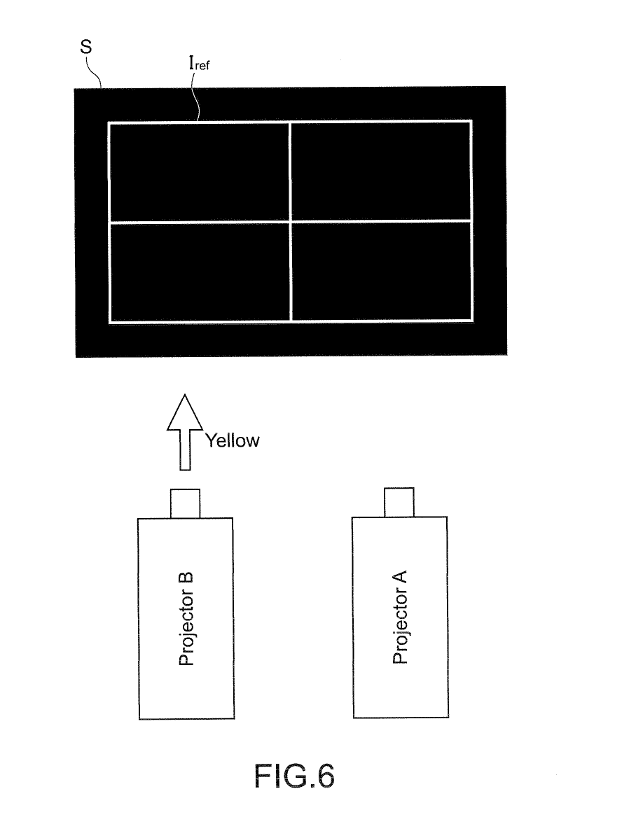

As shown in FIG. 6, the reference pattern image I_{ref} is a synthesized image of the test pattern images I_{A} and I_{B} which are projected by the projectors A and B respectively, and is an image in yellow as synthesized from green and red, for example. In other words, the reference pattern image I_{ref} has the same size and the same shape with the test pattern images I_{A} and I_{B}, and has a combination color of the colors of these test pattern images. That is, the reference pattern image I_{ref} can be regarded as an image in which the test pattern images I_{A} and I_{B} have completely coincided in advance.

The image adjustment apparatus 20 captures this reference pattern image I_{ref} by the camera 10, and takes a reference image which is the captured image thereof (step 102). In other words, the camera 10 captures the reference pattern image I_{ref} which is an ideally coincided image of the test pattern images I_{A} and I_{B}. As a result, the reference pattern image can be regarded as an image having positional deviations only corresponding to chromatic aberrations that occur due to the camera 10. Hereinafter, a positional deviation corresponding to a chromatic aberration will be referred to as “chromatic aberration-derived positional deviation”.

The image adjustment apparatus 20 detects a chromatic aberration-derived positional deviation in a predetermined area out of the above-mentioned nine areas (step 103), and stores data of the detected chromatic aberration-derived positional deviation to a memory or the like. As the predetermined area, one or more areas such as all nine areas; six areas LU, LC, LD, RU, RC and RD; or four corner areas LU, LD, RU and RD, for example, may be set as appropriate.

A state of the captured Image where the chromatic aberration-derived positional deviation has occurred is equivalent to the state of the positional deviation of the test pattern images each being output by the corresponding one of the projectors A and B, locally in the captured image (as seen for each area), for example, as shown in FIG. 2. In particular, the chromatic aberration-derived positional deviation becomes greater at the area closer to the edge of the image. As will be described later, the chromatic aberration-derived positional deviation may be detected by generating comparison data indicating a phase angle balance in the direction of the positional deviation, from a pixel having a peak luminance at the center.

The adjustment by the subsequent steps 104 to 110 is rough adjustment, and the image adjustment apparatus performs the above-mentioned correction processes of FIG.

4. The image adjustment apparatus allows the test pattern images I_{A} and I_{B} to be actually projected on the screen by the projectors A and B, respectively (step 104). The image adjustment apparatus 20 captures the test pattern images I_{A} and I_{B} by the camera 10, and obtains a captured image which includes the captured test pattern images I_{A} and I_{B} (step 105).

The image adjustment apparatus 20 selects one or more areas which would be necessary for performing one predetermined correction process out of the above-mentioned six patterns of correction processes, from among the above-mentioned nine areas of the captured image, and detects the positional deviation for the execution of that correction process (step 106).

In cases where detection for positional deviations of “H Centering” and “V Centering” is performed, the area CC may be selected. In cases where detection for positional deviations of “V Keystone” is performed, the four corner areas LU, LD, RU and RD may be selected. In cases where detection for positional deviations of “H Size” is performed, the areas LC and RC may be selected. In cases where detection for positional deviations of “V Linearity” is performed, the areas CU, CD and CC may be selected.

The image adjustment apparatus 20 determines whether or not the detected amount of positional deviation is equal to or less than a threshold value (step 107). The threshold value is set to be a distance at which the colors of the test pattern images I_{A} and I_{B} are barely prevented from absorbing each other. If the amount of positional deviation is larger than the threshold value, the image adjustment apparatus 20 sends a correction command that corresponds to the correction process to the projector A (step 108). A correction amount by length by a single correction process may be constant as in the above, or may be variable. In cases where the correction amount is variable, the correction command generation unit 23 may have an algorithm such that the correction amount becomes smaller for each time a loop of the steps 105 to 108 is repeated.

The image adjustment apparatus 20 repeats the processes of the steps 105 to 108 until the positional deviation becomes equal to or less than the threshold value.

The image adjustment apparatus 20 executes all the other correction processes in the similar manner, or in other words, executes the remaining five correction processes one by one. If all the correction processes are completed (“YES” of step 109), the rough adjustment is completed.

It should be noted that the order of the above-mentioned six correction processes is not limited, but typically, the correction processes of “V Keystone”, “H Size” and “V Linearity” may be executed after the correction processes of “H Centering”, and “V Centering”. In such cases, the order of the correction processes of “H Centering” and “V Centering” is not limited, and the order of the correction processes of “V Keystone”, “H Size” and “V Linearity” is not limited.

After finishing the above rough adjustment, the image adjustment apparatus 20 performs the fine adjustment in the step 110 and the subsequent steps.

The image adjustment apparatus 20 captures the test pattern images I_{A} and I_{B} after rough adjustment by the camera, and obtains the captured image thereof (step 110). The image adjustment apparatus 20 detects a positional deviation in a predetermined area out of the above-mentioned nine areas in the captured image (step 111). As the predetermined area, one or more areas such as all nine areas; six areas LU, LC, LD, RU, RC and RD; or four corner areas LU, LD, RU and RD, for example, may be set as appropriate. These areas which are the subject of correction are typically corresponding to one or more areas which had the chromatic aberration-derived positional deviation described above.

In the step 111, the image adjustment apparatus 20 makes the detection, as will be described later, by generating comparison data indicating a phase angle balance in the direction of the positional deviation, from a pixel having a peak luminance at the center.

The image adjustment apparatus 20 sets a value of positional deviation after subtracting the amount of aberration-derived positional deviation detected in the above step 103 (a value that corresponds to the aberration-derived positional deviation) from an amount of positional deviation detected by the step 111 (a value that corresponds to the positional deviation) to be an amount of actual positional deviation (step 112). This processing method will also be described later in detail. Further, the image adjustment apparatus 20 sends a command for performing correction by deforming the test pattern image I_{A} in such a manner that the amount of actual positional deviation approaches zero (step 113).

The image adjustment apparatus 20 performs the steps 110 to 112 on other areas, and if these are completed (“YES” of step 114), it ends the processes oh image adjustment.

As described above, in this embodiment, by capturing the reference pattern image I_{ref} projected from a single projector B, by the camera 10, it allows the positional deviation of the test pattern images included in the captured reference image to be regarded as the positional deviation due to the chromatic aberration. By offsetting this chromatic aberration-derived positional deviation from the positional deviations of the pattern images I_{A} and I_{B} each actually being projected on the screen S, the image adjustment apparatus 20 is able to automatically correct, with high precision, the positional deviations of the test pattern images I_{A} and I_{B} each actually being projected.

In this embodiment, by capturing the whole pattern images by the camera 10, a single camera 10 will be enough for functioning as such in the image adjustment system 100, and thus it can reduce costs.

[Method of detecting positional deviation]

Regarding the step 111 in the above processes by the image adjustment apparatus 20, the amount of positional deviation of the test pattern images I_{A} and I_{B} and a method for the detection thereof will be described.

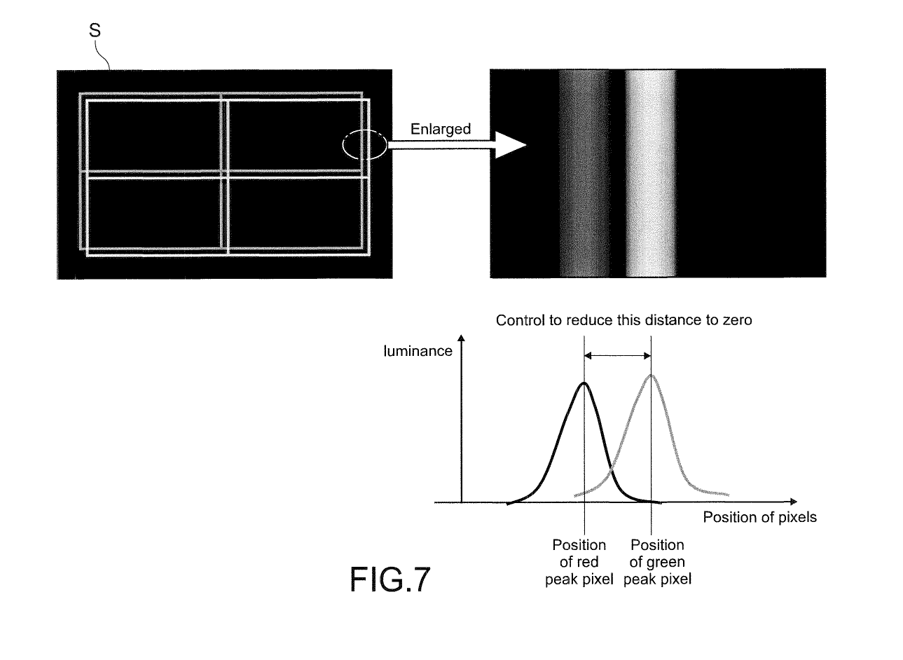

The image adjustment apparatus 20 basically detects the positional deviation in the following manner. The image apparatus 20 detects a pixel having a peak luminance value of green (peak pixel) in the test pattern image I_{B}, and detects a pixel having a peak luminance value of red (peak pixel) in the test pattern image I_{A}. The image adjustment apparatus 20 then executes controlling such that the positions (coordinates) of both of the peak pixels become coincident on the screen S (see FIG. 7).

The enlarged area shown in FIG. 7 is shown as an area other than the above nine areas; and this shows an example of any area having a peak luminance, in an enlarged manner, for ease of understanding.

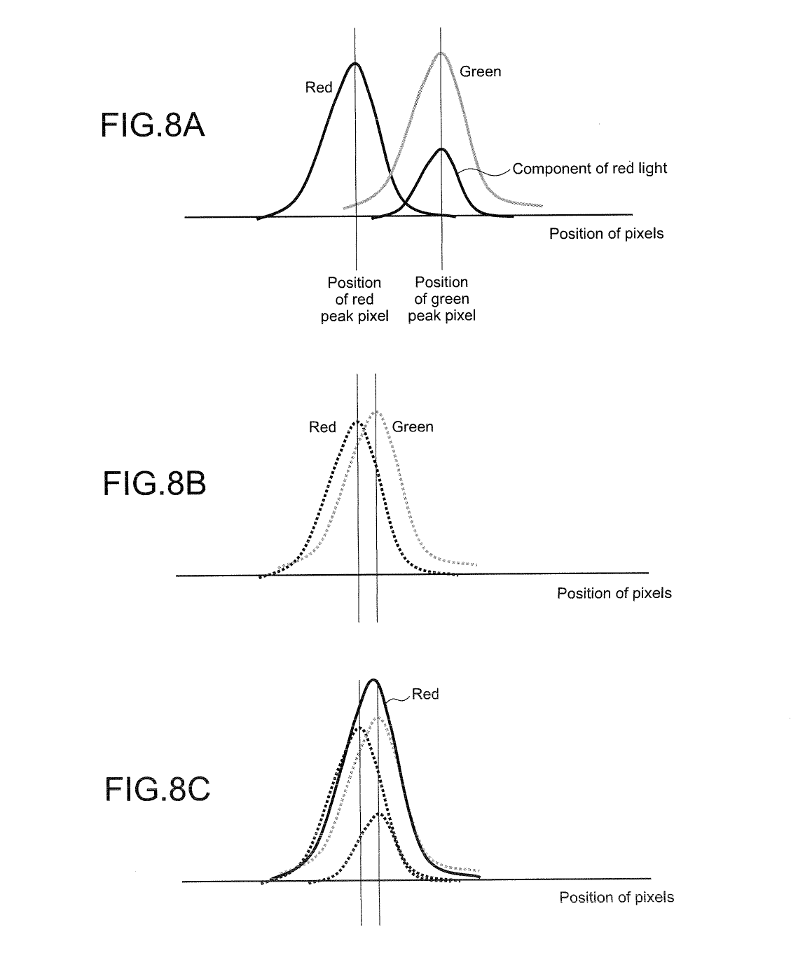

FIG. 8A shows a fact that green light in an image projected from the projector B contains a component of red light. As shown in FIG. 8B, ideally, positions of peak pixels of red and green can be separated from each other. However, in reality where the green light contains a component of red light, as shown in FIG. 80, if the peak pixels of green and red become closer to each other, the position of the red peak pixel and the surrounding pixels would be absorbed into the position of the green peak pixel and the surrounding pixels.

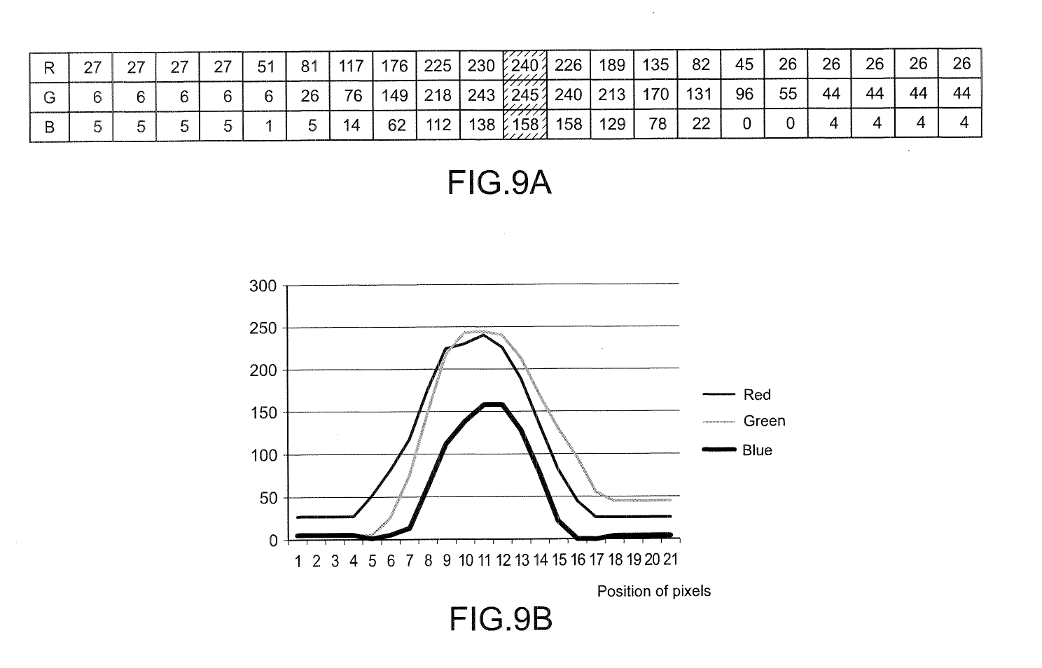

FIGS. 9A and 9B show pixel values for the red peak pixel and for contiguous pixels adjacent thereto in the horizontal direction from the peak pixel at the center, in which the peak pixel and the contiguous pixels are within the captured image obtained by the image adjustment apparatus 20. In FIG. 9A, a pixel shown by a shaded part represents the peak pixel, where a value shown as the data of red sub-pixel is 240, the data of green sub-pixel is 245 and the data of blue sub-pixel is 158. Values of red (R) and green (G) for this peak pixel and for the pixels at the both sides adjacent to this peak pixel are shown to be around 240 which is the peak value of red. FIG. 9B is a graph showing the pixel values for the pixels shown in FIG. 9A.

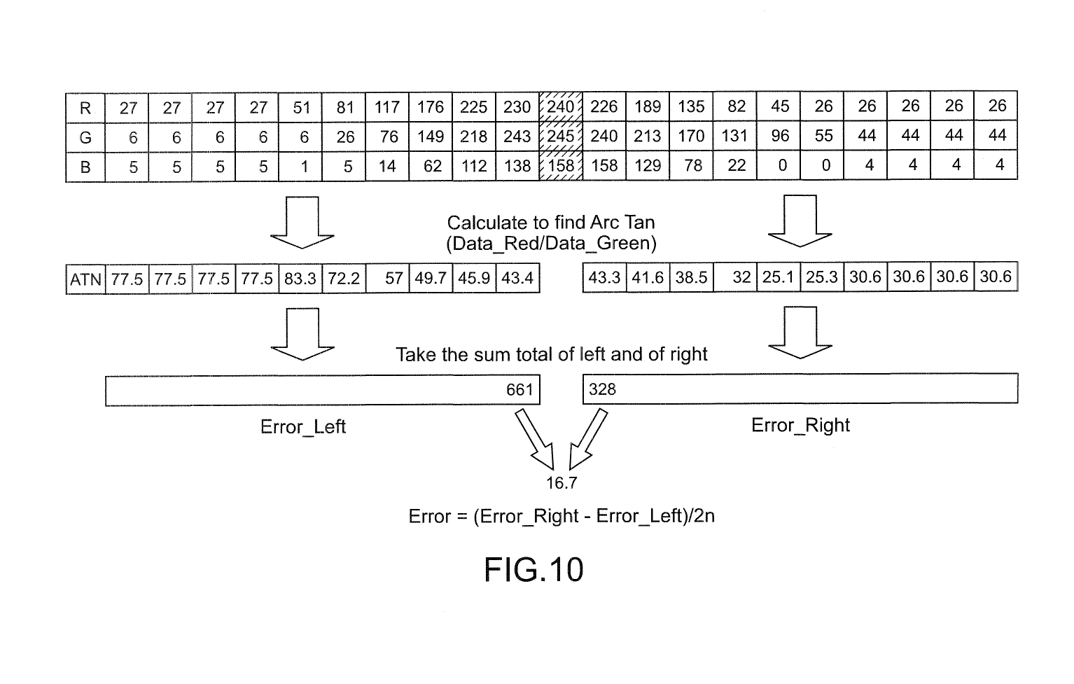

From the facts as described above, it is difficult to make images coincide very precisely by merely comparing the positions of the peak pixels. In view of this, in the present disclosure, the following fine adjustment is performed. FIG. 10 is a diagram explaining this adjustment.

The image adjustment apparatus 20 extracts, from the captured image, the pixel values for at least two pixels located across the peak pixel from each other in a direction of the positional deviation in the predetermined area out of the captured image, and generates comparison data of the extracted pixel values. Specifically, as shown in FIG. 10, the image adjustment apparatus 20 extracts, from the captured image, the pixel value for the peak pixel, as well as the pixel values for ten pixels contiguous to the peak pixel in each side of the peak pixel (twenty pixels in total of the both sides) including the pixels adjacent to the peak pixel, which are located across the peak pixel from each other in a horizontal direction.

In this example, a group of pixels in the horizontal direction is described to be obtained, and this is for explaining a correction process on the positional deviation of the test pattern images I_{A} and I_{B} in the horizontal direction. In a correction process on the positional deviation in the vertical direction, the image adjustment apparatus 20 extracts, from the captured image, the pixel values for at least two pixels located across the peak pixel from each other in the vertical direction in the predetermined area out of the captured image.

The image adjustment apparatus 20 calculates an arctangent value of the ratio of the pixel value of red to the pixel value of green, for each of the ten pixels on the left side from the peak pixel at the center, and for each of the ten pixels on the right side, as in formula (1).

arctan[Data_{—}R(n)/Data_{—}G(n)] (1)

where n indicates the number of pixels to extract (in this example, the number n is 10)

The image adjustment apparatus 20 calculates a sum of the above arctangent values for the pixels on the left, and the same for the pixels on the right, as shown in formulae (2) and (3). These values of the sums will each be defined as the corresponding one of “Error_Left” and

“Error_Right”. The Error_Left value and the Error_Right value function as the comparison data.

Error_Left=Σarctan[Data_{—}R(x−n)/Data_{—}G(x−n)] (2)

Error_Right=Σarctan[Data_{—}R(x+n)/Data_{—}G(x+n)] (3)

That is, the comparison data indicates a phase angle balance between the left and the right from the peak pixel at the center. A larger Error_Left value (Error_Right value) indicates higher contribution of red.

The image adjustment apparatus 20 calculates the difference between the calculated values of left and right of the above and divides the obtained value by 2n for normalization, as shown in formula (4).

Error=(Error_Right−Error_Left)/2n (4)

This Error value may function as the comparison data.

As this Error value becomes closer to zero, the contribution of red in the left side from the peak pixel at the center becomes closer to the same as that of the right side, which indicates that the positional deviation of the test pattern images I_{A} and I_{B} becomes closer to zero. The above detection of the positional deviation can also be applied to the detection of the “chromatic aberration-derived positional deviation” in the step 103. That is, positional deviations can be detected by using the same algorithm between the steps 103 and 111.

Further, the image adjustment apparatus 20 sets the aberration-derived positional deviation that occur due to the camera 10 to be an offset value, as shown in the step 112. In other words, as shown in formula (5), by subtracting the offset value from the Error value obtained by formula (4), the calculated actual positional deviation or R is obtained.

Error_{—}R=Error−Offset (5)

As described above, with the image adjustment apparatus 20 detecting the positional deviation (and the chromatic aberration-derived positional deviation) by using the comparison data indicating the phase angle balance in the direction of the positional deviation from the pixel having the peak luminance at the center, image adjustment with very high precision can be performed.

Further, with the detection of both the positional deviation and the chromatic aberration-derived positional deviation being made by using the same algorithm, the computation cost can be reduced.

### [Other Embodiments]The present disclosure is not limited to the embodiment described above and various other embodiments can be implemented.

A red image and a green image were used as two test pattern images in the above embodiment. However, green and blue, or red and blue, may be employed as the colors of the images.

In the above embodiment, the image adjustment apparatus 20 and the image storage apparatus 30 were the separate apparatus from each other, but they may also be an integrated apparatus thereof. Otherwise, the camera 10 may be integrated with at least one of the image adjustment apparatus 20 and the image storage apparatus 30. Furthermore, at least one of the functions of the image adjustment apparatus 20 and the image storage apparatus 30 may be possessed by any single projector of the plurality of projectors.

In the above embodiment, the image adjustment apparatus 20 generated the correction command and sent it to the projector A, in correcting the positional deviation and correcting the chromatic aberration-derived positional deviation. However, the apparatus for image adjustment may allow the image to be distorted (corrected) on the basis of detection performed by the positional deviation detection unit 22, and may output the corrected image to the projector A.

The image apparatus 20 used the arctangent value of the ratio of the pixel value of the first color to the pixel value of the second color, as shown in the above-mentioned formula (1). However, instead of using formula (1), an embodiment in which the difference between the pixel value of the first color to the pixel value of the second color for each of the pixels is used, for example, one in which [Data_R(n)−Data_G(n)]/[Data_R(n)+Data_G(n)] is calculated may also be possible. Furthermore, instead of using formula (1), the ratio between the pixel value of the first color to the pixel value of the second color for each of the pixels, or in other words, Data_R(n)/Data_G(n) may be simply calculated.

There were two projectors, but three or more projectors may be used as well. In cases where there are three or more projectors, the apparatus for image adjustment is configured to execute the correction processes in such a manner that to one test pattern image, a plurality of other test pattern images would become coincident with the test pattern image.

There was only one imaging apparatus, which was a camera, provided in the above embodiment. However, a plurality of imaging apparatus may be provided. For example, three cameras may each be provided to capture each of the left edge part, the center part and the right edge part of the image on the screen S, and the apparatus for image adjustment may correct each image captured by the corresponding camera, by the same process as in the above embodiment.

At least two characteristic parts out of the characteristic parts of the above embodiments can be combined.

The present disclosure can take the following configurations.

(1) An apparatus for image adjustment, including:
an acquisition unit configured to obtain a reference image obtainable by a reference pattern image being captured by an imaging apparatus,
   the reference pattern image being projected by any single projector out of a plurality of projectors, as a synthesized image of pattern images, each of which pattern images can be projected by a corresponding projector in the plurality of projectors and has a color different to each other, and
   having a combination color of the different colors of the pattern images;
a detection unit configured to detect, on the basis of data of the reference image, a chromatic aberration-derived positional deviation which is defined to be a positional deviation in the pattern images corresponding to a chromatic aberration that occurs due to the imaging apparatus; and
a correction unit configured to correct, using data of the chromatic aberration-derived positional deviation, the positional deviation of the pattern images each being projected by the corresponding projector.

(2) The apparatus for image adjustment according to (1), in which
the detection unit is configured to detect the chromatic aberration-derived positional deviation by
   extracting pixel values, from the data of the reference image, for at least two pixels located across a peak pixel from each other in a direction of the chromatic aberration-derived positional deviation, in which the peak pixel has a peak pixel value obtainable from the data of the reference image, and
   generating comparison data of the extracted pixel values.

(3) The apparatus for image adjustment according to (2), in which
the detection unit is configured to extract, as the pixel values, pixel values for at least two pixels that are adjacent to the peak pixel.

(4) The apparatus for image adjustment according to (2), in which
the detection unit is configured to extract pixel values for a plurality of pixels contiguous to the peak pixel in at least both sides of the peak pixel in the direction of the chromatic aberration-derived positional deviation.

(5) The apparatus for image adjustment according to (4), in which
the detection unit is configured to obtain the comparison data by calculating, using a predetermined algorithm, on the basis of the extracted pixel values.

(6) The apparatus for image adjustment according to (5), in which
the acquisition unit is configured to obtain, as the reference image, an image obtainable by the reference pattern image being captured by the imaging apparatus,
   the reference pattern image having a third color synthesized from a first color of a first pattern image and a second color of a second pattern image, out of the pattern images, each of which pattern images can be projected by the corresponding projector, and
the detection unit is configured
   to extract the pixel value for the first color of the first pattern image and the pixel value for the second color of the second pattern image, for each of the contiguous pixels, and
   to obtain the comparison data on the basis of a sum of arctangent values, of the ratio of the pixel value for the first color to the pixel value for the second color, of the plurality of pixels.

(7) The apparatus for image adjustment according to (5), in which
the acquisition unit is configured to obtain, as the reference image, an image obtainable by the reference pattern image being captured by the imaging apparatus,
   the reference pattern image having a third color synthesized from a first color of a first pattern image and a second color of a second pattern image, out of the pattern images, each of which pattern images can be projected by the corresponding projector, and
the detection unit is configured
   to extract the pixel value for the first color of the first pattern image and the pixel value for the second color of the second pattern image, for each of the contiguous pixels, and
   to obtain the comparison data on the basis of a sum of differences, or ratios, between the pixel value for the first color and the pixel value for the second color, of the plurality of pixels.

(8) The apparatus for image adjustment according to (1), in which
the acquisition unit is configured to further obtain a captured image obtainable by capturing each of the pattern images being projected by the corresponding projector, by the imaging apparatus, and
the detection unit is configured to detect the positional deviation by
   extracting pixel values, from the data of the captured image, for at least two pixels located across a peak pixel from each other in a direction of the positional deviation, in which the peak pixel has a peak pixel value obtainable from the data of the captured image, and
   generating comparison data of the extracted pixel values.

(9) The apparatus for image adjustment according to (8), in which
the correction unit is configured to calculate, as an actual positional deviation, a value after subtracting a value that corresponds to the aberration-derived positional deviation from a value that corresponds to the positional deviation.

(10) The apparatus for image adjustment according to any one of (1) to (8), in which
the detection unit is configured to perform a detection process on at least a predetermined partial area out of the reference image.

(11) An apparatus for image adjustment, including:
an acquisition unit configured to obtain a captured image obtainable by capturing pattern images, each of which pattern images is projected by a corresponding projector in a plurality of projectors and has a color different to each other, by an imaging apparatus;
a detection unit configured to detect a positional deviation by
   extracting pixel values for at least two pixels located across a peak pixel from each other in a direction of the positional deviation in the pattern images, in which the peak pixel has a peak pixel value obtainable from the data of the captured image, and
   generating comparison data of the extracted pixel values; and
a correction unit configured to correct the detected positional deviation.

(12) A system for image adjustment, including:
a plurality of projectors;
an imaging apparatus configured to capture a reference pattern image,
   the reference pattern image being projected by any single projector out of the plurality of projectors, as a synthesized image of pattern images, each of which pattern images can be projected by a corresponding projector in the plurality of projectors and has a color different to each other, and
   having a combination color of the different colors of the pattern images; and
an apparatus for image adjustment, which includes
   an acquisition unit configured to obtain a reference image which is obtainable by being captured by the imaging apparatus,
   a detection unit configured to detect, on the basis of data of the reference image, a chromatic aberration-derived positional deviation which is defined to be a positional deviation in the pattern images corresponding to a chromatic aberration that occurs due to the imaging apparatus, and
   a correction unit configured to correct, using data of the chromatic aberration-derived positional deviation, the positional deviation of the pattern images each being projected by the corresponding projector.

(13) A system for image adjustment, including:
a plurality of projectors;
an imaging apparatus configured to capture pattern images, each of which pattern images is projected by a corresponding projector in the plurality of projectors and has a color different to each other; and
an apparatus for image adjustment, which includes
   an acquisition unit configured to obtain a captured image obtainable by capturing by the imaging apparatus,
   a detection unit configured to detect a positional deviation by
      extracting pixel values for at least two pixels located across a peak pixel from each other in a direction of the positional deviation in the pattern images, in which the peak pixel has a peak pixel value obtainable from the data of the captured image, and
      generating comparison data of the extracted pixel values, and
   a correction unit configured to correct the detected positional deviation.

(14) A method for image adjustment, including:
projecting a reference pattern image as a synthesized image of pattern images, by any single projector out of a plurality of projectors,
   each of which pattern images can be projected by a corresponding projector in the plurality of projectors and has a color different to each other,
   the reference pattern image having a combination color of the different colors of the pattern images;
capturing the reference pattern image by an imaging apparatus;
obtaining a reference image obtainable by the capturing by the imaging apparatus;
detecting, on the basis of data of the reference image, a chromatic aberration-derived positional deviation which is defined to be a positional deviation in the pattern images corresponding to a chromatic aberration that occurs due to the imaging apparatus; and
correcting, using data of the chromatic aberration-derived positional deviation, the positional deviation of the pattern images that are each projected by the corresponding projector.

(15) A method for image adjustment, including:
projecting pattern images by a plurality of projectors, each of which pattern images has a color different to each other and is to be projected by a corresponding projector in the plurality of projectors;
capturing the projected pattern images by an imaging apparatus;
obtaining a captured image obtainable by the capturing by the imaging apparatus;
extracting pixel values for at least two pixels located across a peak pixel from each other in a direction of the positional deviation in the pattern images, in which the peak pixel has a peak pixel value obtainable from the data of the captured image;
detecting the positional deviation by generating comparison data of the extracted pixel values; and
correcting the detected positional deviation.

The present disclosure contains subject matter related to that disclosed in Japanese Priority Patent Application JP 2012-115392 filed in the Japan Patent Office on May 21, 2012, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus for image adjustment, comprising:
an acquisition unit configured to obtain a reference image obtainable by a reference pattern image being captured by an imaging apparatus,
the reference pattern image being projected by any single projector out of a plurality of projectors, as a synthesized image of pattern images, each of which pattern images can be projected by a corresponding projector in the plurality of projectors and has a color different to each other, and
having a combination color of the different colors of the pattern images;
a detection unit configured to detect, on the basis of data of the reference image, a chromatic aberration-derived positional deviation which is defined to be a positional deviation in the pattern images corresponding to a chromatic aberration that occurs due to the imaging apparatus; and
a correction unit configured to correct, using data of the chromatic aberration-derived positional deviation, the positional deviation of the pattern images each being projected by the corresponding projector.

2. The apparatus for image adjustment according to claim 1, wherein
the detection unit is configured to detect the chromatic aberration-derived positional deviation by
extracting pixel values, from the data of the reference image, for at least two pixels located across a peak pixel from each other in a direction of the chromatic aberration-derived positional deviation, in which the peak pixel has a peak pixel value obtainable from the data of the reference image, and
generating comparison data of the extracted pixel values.

3. The apparatus for image adjustment according to claim 2, wherein
the detection unit is configured to extract, as the pixel values, pixel values for at least two pixels that are adjacent to the peak pixel.

4. The apparatus for image adjustment according to claim 2, wherein
the detection unit is configured to extract pixel values for a plurality of pixels contiguous to the peak pixel in at least both sides of the peak pixel in the direction of the chromatic aberration-derived positional deviation.

5. The apparatus for image adjustment according to claim 4, wherein
the detection unit is configured to obtain the comparison data by calculating, using a predetermined algorithm, on the basis of the extracted pixel values.

6. The apparatus for image adjustment according to claim 5, wherein
the acquisition unit is configured to obtain, as the reference image, an image obtainable by the reference pattern image being captured by the imaging apparatus,
the reference pattern image having a third color synthesized from a first color of a first pattern image and a second color of a second pattern image, out of the pattern images, each of which pattern images can be projected by the corresponding projector, and
the detection unit is configured
to extract the pixel value for the first color of the first pattern image and the pixel value for the second color of the second pattern image, for each of the contiguous pixels, and
to obtain the comparison data on the basis of a sum of arctangent values, of the ratio of the pixel value for the first color to the pixel value for the second color, of the plurality of pixels.

7. The apparatus for image adjustment according to claim 5, wherein
the acquisition unit is configured to obtain, as the reference image, an image obtainable by the reference pattern image being captured by the imaging apparatus,
the reference pattern image having a third color synthesized from a first color of a first pattern image and a second color of a second pattern image, out of the pattern images, each of which pattern images can be projected by the corresponding projector, and
the detection unit is configured
to extract the pixel value for the first color of the first pattern image and the pixel value for the second color of the second pattern image, for each of the contiguous pixels, and
to obtain the comparison data on the basis of a sum of differences, or ratios, between the pixel value for the first color and the pixel value for the second color, of the plurality of pixels.

8. The apparatus for image adjustment according to claim 1, wherein
the acquisition unit is configured to further obtain a captured image obtainable by capturing each of the pattern images being projected by the corresponding projector, by the imaging apparatus, and
the detection unit is configured to detect the positional deviation by
extracting pixel values, from the data of the captured image, for at least two pixels located across a peak pixel from each other in a direction of the positional deviation, in which the peak pixel has a peak pixel value obtainable from the data of the captured image, and
generating comparison data of the extracted pixel values.

9. The apparatus for image adjustment according to claim 8, wherein
the correction unit is configured to calculate, as an actual positional deviation, a value after subtracting a value that corresponds to the aberration-derived positional deviation from a value that corresponds to the positional deviation.

10. The apparatus for image adjustment according to any one of claim 1, wherein
the detection unit is configured to perform a detection process on at least a predetermined partial area out of the reference image.

11. An apparatus for image adjustment, comprising:
an acquisition unit configured to obtain a captured image obtainable by capturing pattern images, each of which pattern images is projected by a corresponding projector in a plurality of projectors and has a color different to each other, by an imaging apparatus;
a detection unit configured to detect a positional deviation by
extracting pixel values for at least two pixels located across a peak pixel from each other in a direction of the positional deviation in the pattern images, in which the peak pixel has a peak pixel value obtainable from the data of the captured image, and
generating comparison data of the extracted pixel values; and
a correction unit configured to correct the detected positional deviation.

12. A system for image adjustment, comprising:
a plurality of projectors;
an imaging apparatus configured to capture a reference pattern image,
the reference pattern image being projected by any single projector out of the plurality of projectors, as a synthesized image of pattern images, each of which pattern images can be projected by a corresponding projector in the plurality of projectors and has a color different to each other, and
having a combination color of the different colors of the pattern images; and
an apparatus for image adjustment, which includes
an acquisition unit configured to obtain a reference image which is obtainable by being captured by the imaging apparatus,
a detection unit configured to detect, on the basis of data of the reference image, a chromatic aberration-derived positional deviation which is defined to be a positional deviation in the pattern images corresponding to a chromatic aberration that occurs due to the imaging apparatus, and
a correction unit configured to correct, using data of the chromatic aberration-derived positional deviation, the positional deviation of the pattern images each being projected by the corresponding projector.

13. A system for image adjustment, comprising:
a plurality of projectors;
an imaging apparatus configured to capture pattern images, each of which pattern images is projected by a corresponding projector in the plurality of projectors and has a color different to each other; and
an apparatus for image adjustment, which includes
an acquisition unit configured to obtain a captured image obtainable by capturing by the imaging apparatus,
a detection unit configured to detect a positional deviation by
extracting pixel values for at least two pixels located across a peak pixel from each other in a direction of the positional deviation in the pattern images, in which the peak pixel has a peak pixel value obtainable from the data of the captured image, and
generating comparison data of the extracted pixel values, and
a correction unit configured to correct the detected positional deviation.

14. A method for image adjustment, comprising:
projecting a reference pattern image as a synthesized image of pattern images, by any single projector out of a plurality of projectors,
each of which pattern images can be projected by a corresponding projector in the plurality of projectors and has a color different to each other,
the reference pattern image having a combination color of the different colors of the pattern images;
capturing the reference pattern image by an imaging apparatus;
obtaining a reference image obtainable by the capturing by the imaging apparatus;
detecting, on the basis of data of the reference image, a chromatic aberration-derived positional deviation which is defined to be a positional deviation in the pattern images corresponding to a chromatic aberration that occurs due to the imaging apparatus; and
correcting, using data of the chromatic aberration-derived positional deviation, the positional deviation of the pattern images that are each projected by the corresponding projector.

15. A method for image adjustment, comprising:
projecting pattern images by a plurality of projectors, each of which pattern images has a color different to each other and is to be projected by a corresponding projector in the plurality of projectors;
capturing the projected pattern images by an imaging apparatus;
obtaining a captured image obtainable by the capturing by the imaging apparatus;
extracting pixel values for at least two pixels located across a peak pixel from each other in a direction of the positional deviation in the pattern images, in which the peak pixel has a peak pixel value obtainable from the data of the captured image;
detecting the positional deviation by generating comparison data of the extracted pixel values; and
correcting the detected positional deviation.
